(19) United States
(12) Patent Application Publication
(10) Pub. No.: US 2013/0157236 A1
(43) Pub. Date: Jun. 20, 2013

(54) Dynamic Article for Toilet Training

(71) Applicants: Kaiyuan Yang, Cumming, GA (US); Xuedong Song, Alpharetta, GA (US); Juan Pablo Aragon, Atlanta, GA (US)

(72) Inventors: Kaiyuan Yang, Cumming, GA (US); Xuedong Song, Alpharetta, GA (US); Juan Pablo Aragon, Atlanta, GA (US)

(21) Appl. No.: 13/328,490

(22) Filed: Dec. 16, 2011

(51) Int. Cl. G09B 19/00

(52) U.S. Cl. 434/247

(57) ABSTRACT

A dynamic inflatable pillow for toilet training children has a compartment wherein a gas-generating composition disposed. Once water enters the pillow compartment through water permeable sides, gas is generated and bubbles are released from at least one gas-release outlet. Dyes may be added to the gas-generating composition to create colored effluent. Functional dyes may be printed on the pillow surface(s), which may appear or, disappear when wetted.

### BACKGROUND

The present disclosure relates to an article used for assisting children in toilet training. More specifically, the disclosure relates to an article in the form of a flexible pillow that contains a gas-generating composition to inflate and/or propel the article in water.

Toilet training is almost always challenging for parents and children alike. For some children, training pants that include a signal member to alert a child that they have wet their pants does not work as effectively as a positive reward for using a toilet. Whether dealing with male or female children during toilet training, an article to make urination into a toilet enjoyable can positively encourage this activity.

Prior attempts to encourage children to use a toilet include the use of a semi-permanent target attached to a toilet. However, such devices are not sanitary and are awkward for adults that use the same toilet. There have been other types of devices used to toilet train children such a flushable, floating paper targets. However, such targets tend to sink when wetted, curl and otherwise deform. In addition, they may float to one side of the toilet bowl and stay there, making its use as a target questionable for girls, and at the very least makes it less interesting to the child.

There remains a substantial need for a toilet training article that is relatively low cost, effective and sanitary. There also remains a substantial need for a toilet training article that does not impair toilet function for adults.

### SUMMARY

In one aspect of the disclosure, the toilet training article according to the present disclosure is an inflatable pillow. The pillow defines a compartment wherein a gas-generating composition is disposed. The pillow has at least one outlet located thereon so the gas generating composition is in fluid communication with an environment outside of the pillow compartment.

In another aspect of the disclosure is a method of making a dynamic article used for toilet training. The method includes the following steps: forming a pillow having a compartment by attaching two water-permeable sheets of material together to form a shape, wherein the shape has a line of symmetry; locating a first outlet at a perimeter of the shape; and disposing a gas-propelling composition within the pillow compartment.

Other embodiments as aspects of the disclosure will be in part apparent and in part pointed out hereinafter.

### BRIEF DESCRIPTION OF THE DRAWINGS

FIG. 1 is a plan view of one embodiment of an article according to the present disclosure, the article being in the shape of a fish.

FIG. 2 is a side cross-sectional view of the article of FIG. 1, taken at line 2-2, in an uninflated state.

FIG. 3 is a side cross-sectional view of the article of FIG. 2, in an inflated state.

FIG. 4 is a plan view of a second embodiment of an article according to the present disclosure, the article having more than one compartment.

FIG. 5 is a side cross-sectional view of the article of FIG. 3, taken at line 5-5.

FIG. 6 is a plan view of a third embodiment of an article according to the present disclosure that demonstrates the random movement of the article.

FIG. 7 is a plan view of a fourth embodiment of an article according to the present disclosure that demonstrates the spinning movement of the article.

FIGS. 8A and 8B are plan views of a fifth embodiment of an article according to the present disclosure that demonstrates changing graphics.

Corresponding reference characters indicate corresponding parts of throughout the drawings.

### DEFINITIONS

The term “flexible” refers to pillow materials that are compliant when the pillow is inflated with gas at pressures consistent with the gas generating compositions of the present disclosure.

“Dynamic” is used to refer to 1) the repeated expansion/contraction motion by pressure changes induced by a gas generation chemistry through gas accumulation and release cycles, 2) straight, circular or random movements caused by gas release through gas outlet(s), 3) time-dependent color changes (e.g. patterned or random graphics, pictures, traces, from color(s) to other color(s), etc.)dynamic and/or 4) gas bubbles and color traces that emanate from the gas outlet(s).

“Seam” refers to the place of joinder of two parts, in particular where two or more sheets come together. The seam is desirably a thermal bond, though an adhesive bond or a mechanical bond would be suitable as well.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment can be used on another embodiment to yield a still further embodiment. Thus, it is intended that the present disclosure includes modifications and variations that come within the scope of the appended claims and their equivalents.

The article of the present disclosure is generally directed to a dynamic training aid for positively encouraging children to transition from diapers or training pants to using a toilet. In a most general sense, the article is a pillow that contains a water- or urine-triggered gas-generating composition. Water functions as a media or a solvent by which the reactive gas-generating composition can mix and react. The article not only floats in a toilet bowl, but also moves substantially at the water surface in an entertaining way. This is exciting for the child to see, and it encourages them to visit the toilet when they have the urge to go.

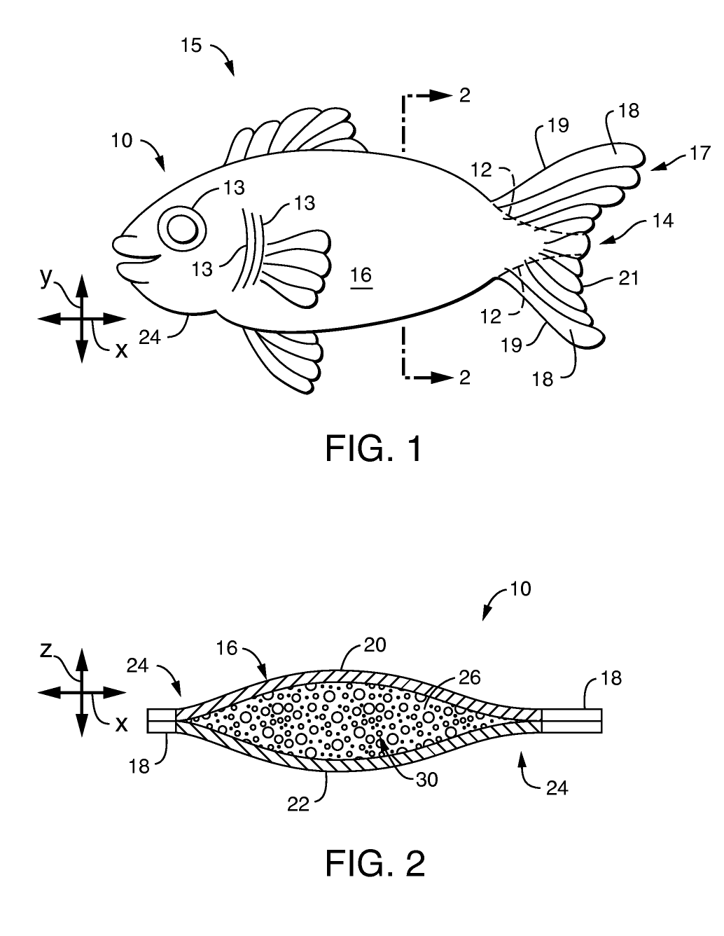

Referring to FIGS. 1 and 2, shown is just one example of an article 10. FIG. 1 is a plan view of an article shaped like a fish, and FIG. 2 is a cross-section thereof. While article 10 is depicted as a fish, article 10 could be of any shape, whether it be an animal, a building, a toy, a common object, a plant, a geometric or an amorphous shape. The shape of the pillow may be merely aesthetic, or it could be at partly functional as shown herein.

Article 10 is made from two sheets 20 and 22 of material sealed together at seam 24. In most cases, the seam 24 coincides with the shape perimeter. However, it is conceivable that one or more portions of the sheet(s) could extend beyond the seam 24, forming appendages as discussed herein.

The seam 14 is not continuous. There is at least one break in the seam 24 to create an outlet 14 for gas to escape the pillow. The outlet allows fluid communication between the pillow contents, including gas, and the aqueous environment in which the pillow contents are activated. It is contemplated that the outlet 14 may be an aperture located in a side of article 10 instead of at a seam between two sides.

Water does not enter the pillow at outlet 14 in any significant amounts. Therefore, at least one of the sheets 20, 22 is water/urine permeable to allow water to enter into the pillow cavity, referred to as compartment 30. It is most desirable if both sheets 20, 22 are water permeable to allow water to more quickly enter compartment 30. It also can be more exciting for boys to urinate on a surface that is water permeable, causing a reaction of the gas-generating composition.

Suitable materials for sheets 20, 22 include paper, tissue, nonwovens, polymer films, woven materials and the like. The sheets are typically hydrophilic, but may be hydrophobic. In another aspect, the sheet may be elastomeric. One desirable material is a 0.1 to 20 mil thick sheet of a water-permeable, flushable, and biodegradable cellulose-based paper-like material. Another preferred material is 0.1 to 5 mil thick sheet of a water permeable polymeric film that is water permeable, flushable, and biodegradable. Sheets 20, 22 may be opaque, translucent or transparent. It is conceivable that the sheets 20 and/or 22 may be made from an apertured non-water permeable material.

Referring to FIG. 2, inside compartment 30 is a composition 26 that releases gas when exposed to either water or urine. When gas is generated, the gas pressure causes the sheets 20, 22 to deform. Because sheets 20, 22 define the compartment, the deformation of the sheets causes compartment 30 to change shape. As a result, article 10, when in a wet state, may appear relatively puffy. Typically, as article 10 puffs, it expands in the z direction and contracts in the y and possibly in the x direction as well.

Suitable materials for composition 26 include a mixture of dry acid/base materials such as citric acid (or any other polymeric acid or acidic media) and sodium bicarbonate or sodium carbonate. When contacted by water, these materials react to form carbon dioxide gas. It is contemplated that other chemistries could be used to generate gases such as nitrogen, carbon monoxide, oxygen and hydrogen. Regardless of the composition used, the resulting gas should be harmless to humans because it is either inert or beneficial, or because an insignificant amount of gas is produced. The ratio of each acid to base is desirably stoichiometric (e.g. pertaining to or involving substances that are in the exact proportions required for a given reaction), but the ratios can be varied to optimize the amount of the gas being generated or to achieve desired dynamic effects.

In one aspect of the disclosure, pigment is added to the composition 26. For instance, dry food-coloring or other safe and dry water-soluble dyes may be blended with composition 26 to form a homogenous blend. When water causes the actives to react, the water also dissolves the dye. The dye may create a colored trace that emanates from article 10, and may even color the entire toilet bowl. Desirably, the dye has the appearance of a white powder or a very pale color until it contacts water or urine to generate a rich vibrant color.

Other optional additives to the composition include an anti-microbial formulation, a deodorizer and/or perfume.

A secondary dynamic effect is obtained when the gas-generation chemistry and dye are released simultaneously either in or at the water surface of the toilet bowl. This is particularly exciting for children to see as it forms random and very dynamic gas bubbles and/or colored movement traces (that may range from a light color to a very deep color). The secondary dynamic effect may be even more dramatic when multiple pigments are mixed together.

In another aspect, the dye included in composition 26 may be functional in that it is sensitive to water, salts, urine, temperature or another stimulus. In one aspect, warm urine may cause a color change, encouraging a child to hit the color emanating from article 10 with a stream of urine. If the sheet 20, viewed from the top of the article 10, is translucent or transparent, the color of the article may change as the composition 26 is wetted. For example, if composition 26 and a dye appears white when blended, water may activate the color so that the composition 26 changes color before it is even released to the surrounding environment.

When gas is produced by reacting composition 26 with water, gas escapes compartment 30 at outlet 14. It may be desirable to create a narrowing of the compartment 30 that culminates at outlet 14. For example, referring to FIG. 1, the contour of seam 24 narrows from the midsection 15 of the fish shape to the tail end 17. The seam 24 includes end sections 12 (represented by dashed lines) that converge toward the outlet 14. The purpose of the narrowing is to create a nozzle that can be used to direct the article 10 and to increase the velocity of article 10 as the escaping gas propels the article at the water surface.

Appendages 18 may be formed by extending sheet 20 and/or 22 beyond seam 24. One example of such an extension is shown in FIG. 1. The fish tail has two appendages 18, each defined by edges 18 and 19, and seam end-sections 12. There is no need to have a seam at edges 18 and 19 unless it is desired. A second example of appendages 18 are shown in FIG. 4. Article 10 is squid-shaped, and the corresponding appendages 18 represent arms. Appendages may be part of a design, and/or may function as tabs for handling article 10.

Referring back to FIG. 1, in one aspect, graphics 13 at are visable at the outer top surface 16 of sheet 20. The graphics may be permanent and/or “functional”. Functional graphics are formed from functional inks that either change color when wetted, disappear when wetted, or appear when wetted. For example, the graphics 13 in the form of a fish eye and gills may only appear after the article 10 has been wetted.

Exemplary color-appearing inks include leuco dyes. Leuco dyes are typically combined with suitable developers, desensitizers and binders. Other additives may be used to adjust the physical properties of the composition. For instance, the composition may contain reagents to adjust the viscosity of the solution, or may include chemicals to improve adhesion of the composition to certain substrate surfaces upon drying. The composition may further include chemistry that tailors the composition's subsequent wettability on the substrate surface.

Leuco dyes are generally referred to as colorless or pale-colored basic dyes, because the dye molecules can acquire two forms, one of which is colorless. The leuco dyes that may be employed can be selected from a variety of dyes including, for example, phthalide leuco dyes, triarylmethane leuco dyes, and fluoran leuco dyes. Examples may include (1) Triarylmethane-based dyes, e.g. 3,3-bis(p-dimethylaminophenyl)-6-dimethylaminophthalide, 3,3-bis(p-dimethylaminophenyl)phthalide, 3-(p-dimethylaminophenyl)-3-(1,2-dimethylindol-3-yl)phthalide, 3-(p-dimethylaminophenyl)-3-(2-methylindol-3-yl)phthalide, 3,3-bis(1,2-dimethylindo1-3-yl)-5-dimethylaminophthalide, 3,3-bis(1,2-dimethylindo1-3-yl)-6-dimethylaminophthalide, 3,3-bis(9-ethylcarbazol-3-yl)-6-dimethylaminophthalide, 3,3-bis(2-phenylindol-3-yl)-6-dimethylaminophthalide, 3-p-dimethylaminophenyl-3-(1-methylpyrrol-3-yl)-6-dimethylaminophthalide, etc. (2) Diphenylmethane-based dyes, e.g., 4,4′-bisdimethylaminobenzhydryl benzyl ether, N-halophenylleucoauramine, N-2, 4,5-trichlorophenyl-leucoauramine, etc. (3) Lactam-based dyes, e.g., rhodamine-B-anilinolactam, rhodamine-(p-nitroanilino)lactam, rhodamine-(o-chloroanilino)lactam, etc. (4) Fluoran-based dyes, e.g., 3-dimethylamino-7-methoxyfluoran, 3-diethylamino-6-methoxyfluoran, 3-di-ethylamino-7-methoxyfluoran, 3-diethylamino-7-chlorofluoran, 3-diethylamino-6-methyl-7-chlorofluoran, 3-di-ethylamino-6,7-dimethylfluoran, 3-(N-ethyl-p-toluidino)-7-methylfluoran, 3-diethylamino-7-(N-acetyl-N-methylamino)fluoran, fluoran, 3-diethylamino-7-(N-methylamino)fluoran, 3-diethylamino-7-dibenzylaminofluoran, 3-diethylamino-7-(N-methyl-N-benzylamino)fluoran, 3-diethylamino-7-(N-chloroethyl-N-methylamino)fluoran, 3-diethylamino-7-N-diethylaminofluoran, 3-(N-ethyl-p-toluidino)-6-methyl-7-phenylaminofluoran, 3-(N-ethyl-p-toluidino)-6-methyl-7-(p-toluidino) fluoran, 3-diethylamino-6-methyl-7-phenylaminofluoran, 3-dibutylamino-6-methyl-7-phenylaminofluoran, 3-diethylamino-7-(2-carbomethoxyphenylamino) fluoran, 3-(N-cyclohexyl-N-methylamino)-6-methyl-7-phenylaminofluoran, 3-pyrrolidino-6-methyl-7-phenylaminofluoran, 3-piperidino-6-methyl-7-phenylaminofluoran, 3-diethylamino-6-methyl-7-(2,4-dimethylamino)fluoran, 3-diethylamino-7-(o-chlorophenylamino)fluoran, 3-dibutylamino-7-(o-chlorophenylamino)fluoran, 3-pyrrolidino-6-methyl-7-(p-butylphenylamino) fluoran, 3-(N-methyl-N-n-amylamino)-6-methyl-7-phenylaminofluoran, 3-(N-ethyl-N-n-amylamino)-6-methyl-7-phenylaminofluoran, 3-(N-ethyl-N-isoamylamino)-6-methyl-7-phenylaminofuluoran, 3-(N-methyl-N-n-hexylamino)-6-methyl-7-phenylaminofluoran, 3-(N-ethyl-N-n-hexylamino)-6-methyl-7-phenylaminofluoran, 3-(N-ethyl-N-β-ethylhexylamino)-6-methyl-7-phenylaminofluoran, etc. The basic dyes useful in this invention are not limited to those exemplified above, and at least two of them can be used in admixture.

All the components in the color-changing composition are soluble in one or more volatile organic solvents, such as solvents used for flexographic and gravure printing. Like the leuco dyes, the color-developers generally exhibit good solubility in organic solvents. Suitable volatile organic solvents may include, for example, ethanol, methanol, propanol, isopropanol, butanol, acetone, tetrahydrofuran (THF), benzene and toluene, methylene chloride, chloroform, or combinations thereof. The volatile organic solvent evaporates when the color-changing composition is applied to the substrate.

Binders are used for at least three reasons. First, binders serve to make the color-changing composition more viscous and therefore, more suitable for printing. Second, binders serve to protect the molecules responsible for the color change from environmental moisture experienced as humidity. Finally, binders create stronger adhesion between the composition molecules and the support onto which the color-changing composition will be disposed. Suitable binders include nitrocellulose, cellulose acetate propionate, cellulose acetate butyrate and other non-water soluble binders.

The functional ink can be deposited on the inner or outer surfaces of sheets 20, 22 by printing methods (e.g. flexographic and gravure), silk screening, spraying, dipping and the like. The wetness indicating inks may be air-dried and have a colorless or nearly colorless state of appearance (i.e., either no color or very weak background shade).

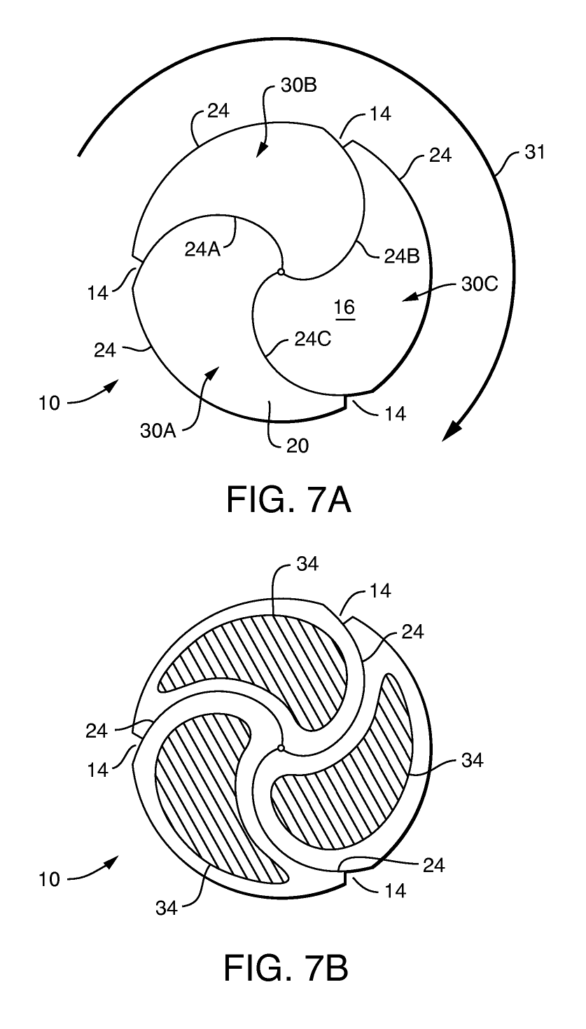

In other aspects, permanent graphics may be initially masked by a disappearing ink. For example, as seen in FIG. 7A, the article is generally round, and has a design defined by the seams 24 that is visible at surface 16. The surface, at least in part, is covered by a masking ink which can be any color. Once wetted, the masking ink becomes translucent or transparent revealing indicia 34. It is further contemplated that a mask could be a film, woven or nonwoven material instead of an ink. Such a material becomes translucent or transparent when wetted, revealing any graphics underneath the mask material.

Referring back to FIGS. 1-3, article 10 is activated by placing it in water 35, such as that found in a toilet 36. (See FIG. 6). In the alternative, one may place the article 10 in a potty-training chair with enough water therein to activate article 10. In a less desirable alternative, one may place article 10 in a dry potty-training chair and leave it there to be urinated upon, relying on an adequate amount of urine to cause article 10 to float.

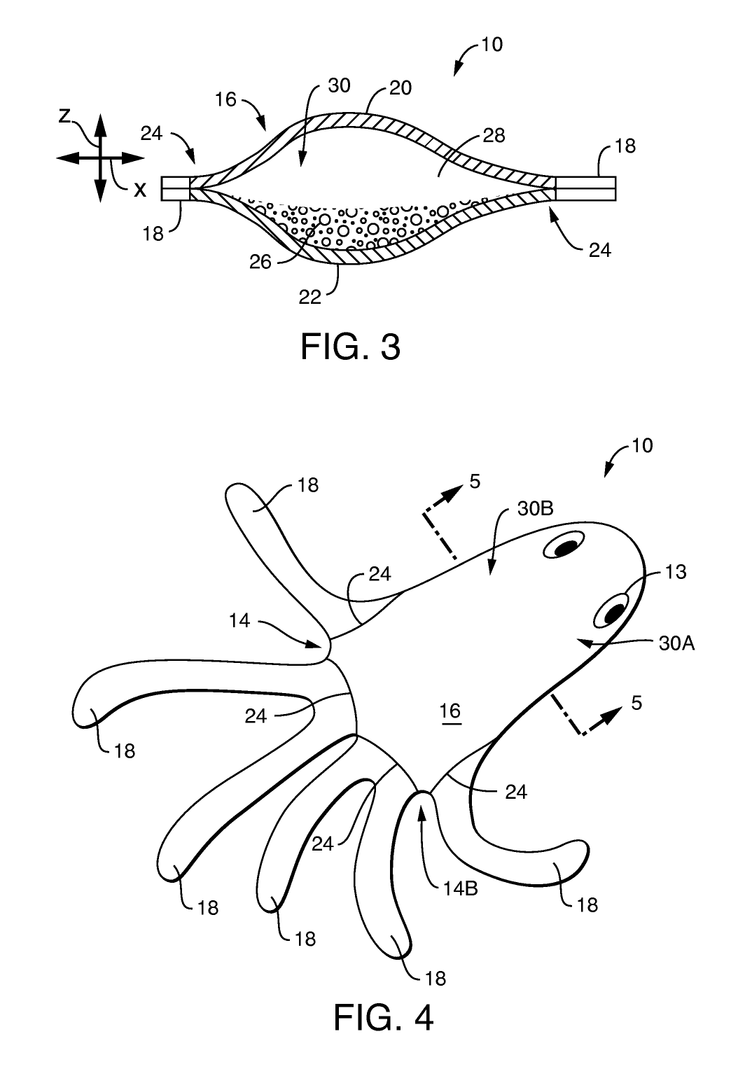

Once article 10 is placed in water, it will float at or just below the water surface. Once wetted, any externally located functional-graphics 13 are activated. Water enters into each pillow compartment 30 through the sheets defining the article 10 sides, where it will cause the gas-generating composition 26 to react. The article 10 will then go from the uninflated state as seen in FIG. 2, to an inflated state as seen in FIG. 3.

As seen in FIG. 3, one large gas pocket 28 may be formed within the compartment 30. Of course, though not shown, there may be more than one gas pocket 28 formed by the reaction because water may be penetrating each side 20, 22, at varied rates, causing varied reactions over the composition 26 mass.

As gas is formed, the pressure within the compartment 30 builds until it is released from the compartment at an outlet 14. The release of gas will propel article 10 at or just below the water surface, in a linear or non-linear fashion.

Therefore, in use, article 10 exhibits several dynamic features. First, as gas is formed, article 10 will inflate, release gas and re-inflate multiple times. This makes article 10 appear to breathe or be alive. Second, the repeated inflation of article 10 may cause a slight wake in the surrounding water. Third, the bubbles emanating from article 10 cause it to move about the surface of the water. Finally, the bubbles and optional colored effluent are in motion as the article 10 is in use.

The movement of article 10 may start as soon as it is placed in water, and desirably lasts for about one to five minutes. In another aspect, the movement of article begins after about 30 to 60 seconds so that the movement occurs after urination occurs.

The movement of article 10 can be somewhat controllable depending on article 10 symmetry and outlet 14 location. For instance, it is anticipated that an article 10, having a single outlet located along the article line of symmetry, may move in a substantially linear fashion. In the alternative, an article 10, having a single outlet away from a line of symmetry, may move in a more random fashion. Multiple, spaced-apart outlets may also cause article 10 to move in a random fashion. For example, article 10 of FIG. 6 is shown as moving in a random direction 38.

In another aspect of the present disclosure, the article 10 may be propelled in a manner that causes it to spin. Referring to FIGS. 7A and 7B, article 10 is a substantially round shape. Here, article 10 is made with a top sheet 20 and bottom sheet 22 (not shown), similar to the article of FIGS. 1 and 2. However, different from FIGS. 1 and 2, the article 10 of this embodiment has multiple side-by-side compartments, 30A, 30B and 30C. Each compartment is defined by a perimeter seam 24 and an inner seam 24A, 24B or 24C. Each compartment shape is substantially identical to one another so that article 10 is symmetric. In this example, each compartment inherently forms a nozzle shape.

Each compartment 30A, 30B and 30C has an outlet 14 from which gas may escape. Each outlet is located between a perimeter seam 24 and an inner seam 24A, 24B and 24C. The angle of the outlet 14 edge may be about 90 degrees with respect to the perimeter seam, though this angle could vary to achieve different dynamic effects. As shown in FIG. 7A, when gas exits each outlet 14, article 10 will be propelled to spin in a clockwise direction 31.

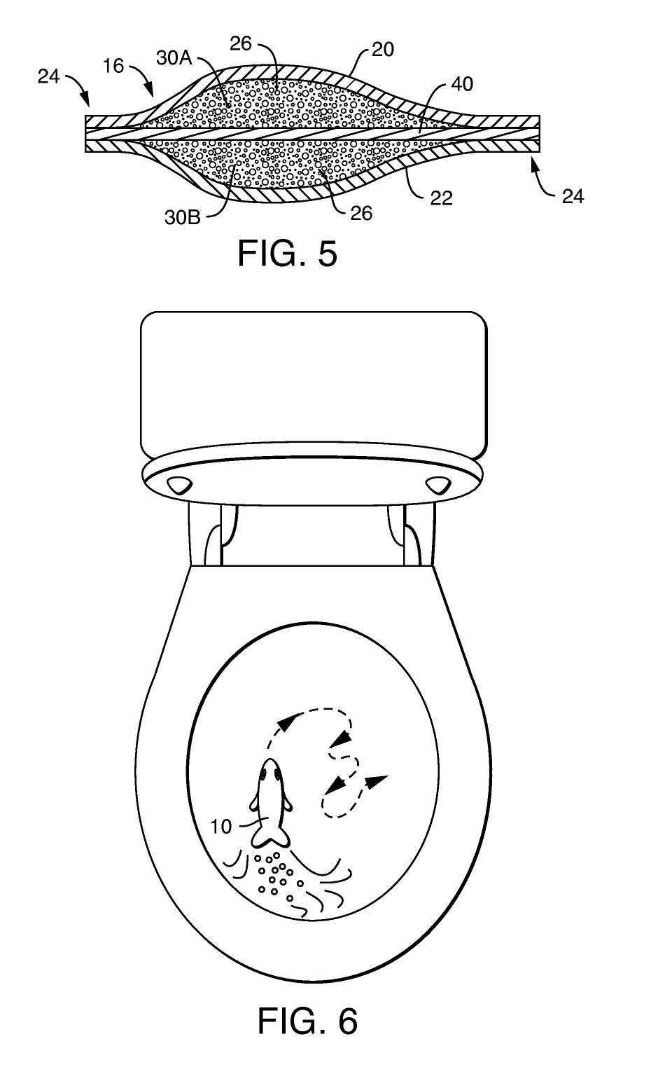

Referring now to FIGS. 4 and 5, shown is another aspect of the present disclosure. In this aspect, two compartments 30A and 30B are stacked, separated by a membrane 40 which is exaggerated in thickness for ease of illustration. Membrane 40 may be made with a water soluble or water permeable polymeric film, nonwoven, woven or tissue material, having a thickness ranging from 0.1 to 10 mil.

Desirably, like a typical tea bag, membrane 40 immediately allows free fluid-communication between two compartments. Examples of such a material include tissue; water-soluble, polyvinyl-alcohol-based polymer films or water-soluble nonwovens. In another aspect, membrane 40 is water impermeable so that there is a first reaction when compartment 30B is exposed to water, and a second reaction when compartment 30A is exposed to urine.

Membrane 40 may vary in stiffness, ranging from very low stiffness to such a high stiffness such that membrane 40 is rigid. A relatively stiff membrane 40 will cause the compartments 30A and 30B to deform less, thereby increasing the rate at which gas exits the respective outlets 14, assuming sheets 20, 22 do not have significant elastic properties.

Membrane 40 may be water insoluble to keep the compartments separated, or may be water soluble at a relatively slow rate of solubility. In the latter case, the article 10 is more dispersible.

The physical separation of the acid and base components of the gas-generation chemistry can prevent premature reaction under moist conditions. In one aspect of the disclosure, the separate compartments as shown in FIGS. 4 and 5 can be used to separate the acidic and basic components of the gas-generation chemistry. In this case, the acid component(s) are in one compartment, and the base component(s) are in a second compartment. In yet another aspect, one or both of the acidic and basic components may be coated or encapsulated with a water-soluble coating, e.g. a polymer, as known in the art. This allows the creation of a homogenous blend of acid and base components without premature reaction.

Referring now to FIG. 4, compartments 30A and 30B may have a stacked outlets 14 or separated outlets 14. For instance, gas from each compartment 30A, 30B could exit simultaneously at outlets 14A and 14B. In the alternative, compartment 30A could exit only from outlet 14A, and gas from compartment 30B could exit only from outlet 14B. Regardless, having two outlets 14 associated with a non-symmetric shape encourages random motion of article 10.

As mentioned, composition 26 may include dyes. An article 10 having more than one compartment 30 provides an opportunity to have different colors exit each different compartment as gas leaves article 10. For example, the article of FIG. 4 may have blue dye exiting from outlet 14A, and red dye exiting outlet 14B. The article of FIG. 7A may have magenta dye exiting from compartment 30A, yellow dye exiting compartment 30B and red dye exiting from compartment 30C. Of course, any color combination may be used. The multiple colors mix to form new colors, and serves to provide additional entertainment for the child.

Another source of entertainment for the child is the noise produced by the gas bubbles exiting outlet(s) 14. Gas bubbles may be further exaggerated by adding a foaming agent, such as surfactant, to the composition 26. A surfactant, in small amounts, facilitates the formation of foam or enhances its colloidal stability by inhibiting the coalescence of bubbles. Suitable surfactants include, but are not limited to, sodium laurel sulfate, sodium lauryl ether sulfate, sodium dodecyl sulfate and ammonium lauryl sulfate. If composition 26 includes a dye, the foam will be colored as it exits the article 10.

Overall, the article 10 may be non-flushable or flushable, and/or dispersible and/or biodegradable. In other aspects, article 10 will dissolve after being in water for a period of time.

It may be desirable to attach a string to the article 10 for lifting from or placing into the toilet bowl. The string may be integral to the article design, for instance, the article could be a balloon and the string extending from near the outlet area of the balloon.

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the disclosure so further described in such appended claims.

1. An article for toilet training comprising:
an inflatable pillow defining a first compartment, the pillow having an outer surface and an inner surface; and
a gas generating composition disposed within the compartment;
wherein pillow comprises a first outlet located thereon so the gas generating composition is in fluid communication with an environment outside of the pillow compartment.

2. The article of claim 1 wherein the pillow is made from a hydrophilic material.

3. The article of claim 1 comprising a second outlet located on the pillow, wherein the first outlet is spaced apart from the second outlet.

4. The article of claim 1 wherein the pillow further comprises a first side joined to a second side at a seam, wherein the first outlet is located in the seam.

5. The article of claim 4 further including indicia visible from the outer surface, wherein the indicia comprises a functional ink.

6. The article of claim 4 further comprising a second outlet, the second outlet is located in the seam, wherein the first outlet and the second outlet are spaced apart from each other.

7. The article of claim 1 wherein the gas generating composition comprises a dye.

8. The article of claim 1 wherein the gas generating composition comprises multiple dyes of different hues.

9. The article of claim 1 wherein the flexible side comprises permanent indicia that can be viewed at the outer surface.

10. The article of claim 1 further comprising a string member attached to the article at the inner or the outer surface.

11. The article of claim 1 further comprising a second compartment separated from the first compartment by a membrane.

12. The article of claim 1 wherein the perimeter defines a shape selected from the group consisting of an animal, a fish, a geometric, a plant, a toy, a machine and a building.

13. The article of claim 12 wherein the first outlet coincides with a feature of the shape that is defined by a graphic.

14. The article of claim 1 wherein the pillow is made from a hydrophobic material having pores or apertures for allowing water to access the gas generating composition.

15. The article of claim 1 wherein the first compartment is subdivided to form separate compartments, wherein one of separate compartments has the first outlet, and the each remaining separate compartments has an outlet corresponding thereto.

16. A method of propelling an article for toilet training, the method comprising the steps of:
forming a pillow having a first compartment by attaching two water-permeable sheets of material together to form a shape, wherein the shape has a line of symmetry;
locating a first outlet at a perimeter of the shape; and
disposing a gas-propelling composition within the pillow compartment.

17. The method of claim 16 further comprising the step of locating one or more additional outlets at the perimeter, wherein the first outlet and the one or more additional outlets are positioned such that the article spins when placed in an aqueous environment.

18. The method of claim 16 further comprising the step of locating a second outlet at the perimeter, wherein the first outlet and the second outlet are spaced apart in a non-symmetric fashion with respect to the line of symmetry so that the article moves randomly when placed in an aqueous environment.

19. The method of claim 16 further comprising the step of locating a second outlet at the perimeter, wherein the first outlet and the second outlet are spaced apart, and wherein the gas-propelling composition includes first dye that is emitted from the first outlet and a second dye, different in hue from the first dye, that is emitted from the second outlet.

20. The method of claim 19 further comprising the step of dividing the first compartment to create a second compartment.
